(19) United States
(12) Patent Application Publication
(10) Pub. No.: US 2013/0057132 A1
(43) Pub. Date: Mar. 7, 2013

(54) Basket Assembly For Dishwasher

(71) Applicants: Christopher Lynn Flowers, Humboldt, TN (US); Debra Lynn Bengtson, Jackson, TN (US)

(72) Inventors: Christopher Lynn Flowers, Humboldt, TN (US); Debra Lynn Bengtson, Jackson, TN (US)

(21) Appl. No.: 13/602,785

(22) Filed: Sep. 4, 2012

Related U.S. Application Data
(60) Provisional application No. 61/530,672, filed on Sep. 2, 2011.

(51) Int. Cl. A47L 15/50; A47L 15/42; B23P 11/00

(52) U.S. Cl. 312/228.1; 29/428; 211/70.7

(57) ABSTRACT

A basket assembly for a dishwasher having a wash chamber with upper and lower dish racks that are movable between an interior of the wash chamber and an exterior of the wash chamber. The basket assembly includes a basket body disposed between the upper and lower racks on a slide mechanism, which enables sliding linear movement of the basket body between the interior of the wash chamber and the exterior of the wash chamber independent of movement of the upper rack and the lower rack. In one aspect, the basket body is removable from and attachable within the wash chamber without tooling.

### RELATED APPLICATIONS

This application claims the benefit of U.S. Provisional Patent Application No. 61/530,672, filed Sep. 2, 2011, which is hereby incorporated by reference, for all purpose, in its entirety herein.

### TECHNICAL FIELD

The present invention generally relates to dishwashers and other similar cleaning systems, and in particular to adjustable racks or baskets for use in a dishwasher for securely holding elongate and/or irregularly shaped objects within the dishwasher.

### BACKGROUND OF THE INVENTION

Dishwashers are a modern convenience found in almost every home in the United States for cleaning and drying dishes. Modern dishwashers typically have a number of convenience settings or features, including heavy duty or delicate cleaning cycles for cleaning heavily soiled dishes, pots and pans, as well as more delicate dishes and cookware such as fine china and crystal. Many conventional dishwashers further are designed with adjustable racks for containing different types of dishes, pots and pans, and other cookware. For example, the upper racks of some conventional dishwashers, which generally are used for glassware and more delicate articles, can be adjustable vertically to accommodate glasses or stemware of varying height and other cookware. The upper racks can also include various adjustable or foldable rack sections therein. Likewise, the lower racks, which generally are used for larger dishes, pots and pans, and the like also can include foldable or adjustable rack sections that enable the racks to be reconfigured to accommodate pots and pans of varying size, etc. In addition, the lower racks typically include utensil baskets near the front or side portions of the lower racks with vertical dividers for separating and aligning utensils in a vertical orientation.

However, while those conventional dishwasher racks are adjustable to accommodate glasses, pots and pans, dishes, etc. of varying size, there still remain certain types of cookware, such as elongate spoons, spatulas, meat forks and other, similar utensils that do not easily and securely fit within conventional dishwasher racks. For example, such certain types of cookware can be between eight to twelve inches in length, and generally do not easily fit within conventional utensil baskets in a secure position, as their increased length can tend to cause such utensils to become easily dislodged from the basket during a washing operation, and/or further can interfere with the vertical adjustment of the upper rack to accommodate varying size glassware or other delicate cookware. Such certain types of cookware therefore often are simply placed in a flat lying position in the upper rack, which can interfere with the placement of dishes or glassware therein, and which can result in the elongate objects shifting or possibly becoming dislodged as they are engaged by high pressure water sprays during a cleaning operation. Further, while some dishwashers may include trays mounted above the upper rack that allow for placement of elongate utensils such as spoons, knives, etc., therein, such upper trays typically are of limited sizes and configurations in order to avoid interference with the vertical adjustment of the upper rack or the roof of the dishwasher. Further, such trays mounted above the upper rack typically can only accommodate substantially flat items and cannot accommodate non-flat items such as spatulas, spoons, and the like.

Accordingly, it can be seen that a need exists for a rack or basket assembly for dishwashers that addresses the foregoing and various other related and unrelated problems in the art.

### SUMMARY

In one embodiment, a basket assembly for a dishwasher having a wash chamber with upper and lower dish racks slidably disposed therein and which are movable between an interior of the wash chamber and an exterior of the wash chamber is provided. The basket assembly includes a basket body that is slidably disposed within the wash chamber on a slide mechanism that is generally mounted between the upper and lower racks. The slide mechanism can provide for sliding linear movement of the basket body between the interior of the wash chamber and the exterior of the wash chamber, and which movement is independent of movement of the upper rack and the lower rack. In one aspect, the basket body and/or the slide mechanism includes a plurality of complimentary attachment fixtures that allow the basket body to be alternately removed from and subsequently re-attached within the wash chamber without tooling.

In another aspect, a dishwasher for cleaning elongate cookware and utensils that includes a base panel, a back panel, a top panel, and first and second side panels that together define a wash chamber having a front opening. The dishwasher also includes a door configured to close the front opening with a water-tight seal and an upper rack and a lower rack that are movable through the front opening when the door is open. The dishwasher further includes a basket body disposed between the upper rack and the lower rack and a slide mechanism that supports the basket body within the wash chamber and enables movement of the basket body through the front opening that is independent of movement of the upper rack and the lower rack. As stated above, the basket body and/or the slide mechanism can include a plurality of complimentary attachment fixtures that allow the basket body to be alternately removed from and re-attached within the wash chamber without tooling.

In yet another aspect, a method of cleaning elongate cookware and utensils in a dishwasher having a wash chamber with an upper rack and a lower rack that are movable between an interior of the wash chamber to an exterior of the wash chamber. The method includes inserting a basket body into the interior of the wash chamber and removably attaching the basket body to a slide mechanism mounted to at least one of the upper rack, the lower rack, and a side panel of the wash chamber. The method also includes sliding the basket body supported on the slide mechanism to the exterior of the wash chamber, with the sliding movement of the basket body being independent of movement of the upper rack and the lower rack, to present a receptacle for elongate utensils which is formed therein. The method further includes placing at least one elongate utensil within the receptacle and sliding the basket body supported on the slide mechanism inwardly into the interior of the wash chamber.

### BRIEF DESCRIPTION OF THE DRAWINGS

FIG. 1 is a perspective view illustrating a dishwasher including a representative embodiment of a basket assembly.

FIG. 2 is a perspective view of the dishwasher of FIG. 1, with the basket assembly in an outwardly extended and loading position.

FIG. 3 is a perspective illustration of the basket assembly of FIGS. 1-2.

FIGS. 4A-4B are perspective illustrations of the slide mechanism of the basket assembly of FIGS. 1-3.

FIG. 5 is a perspective view of a wash chamber of a dishwasher showing the slide mechanism of FIGS. 4A-4B mounted thereto.

FIGS. 6A-6B are close-up perspective illustrations of the basket assembly of FIGS. 1-3.

FIG. 7 is a perspective illustration of another representative embodiment of a basket assembly.

According to common practice, various features of the drawings discussed below are not necessarily drawn to scale. Dimensions of various features and elements illustrated in the drawings may be expanded or reduced to more clearly illustrate the embodiments of the disclosure. In addition, those skilled in the art will appreciate that there are various advantages and benefits of various embodiments of the present invention, upon reading the following detailed description, with reference to the accompanying drawings.

### DETAILED DESCRIPTION

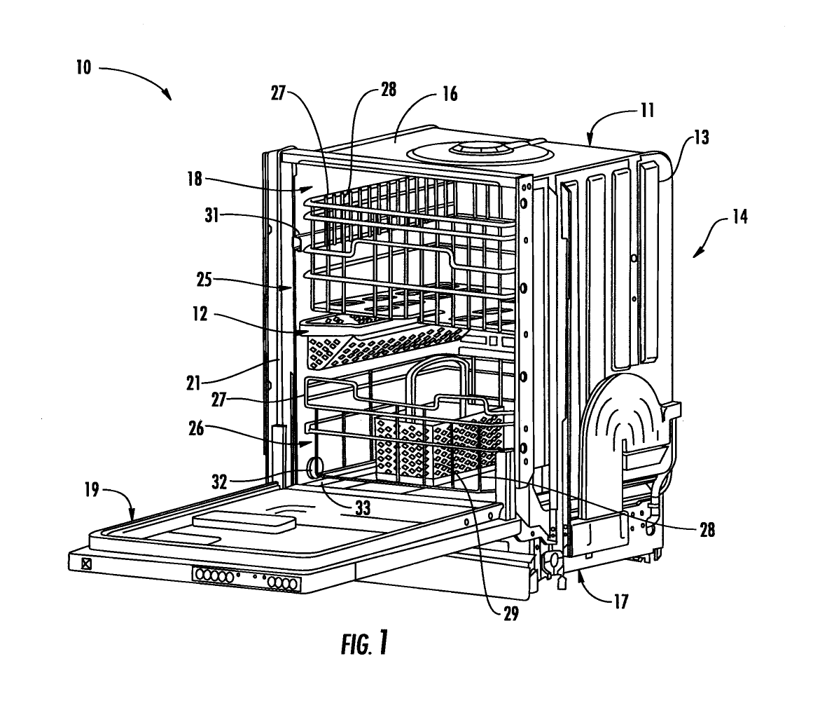

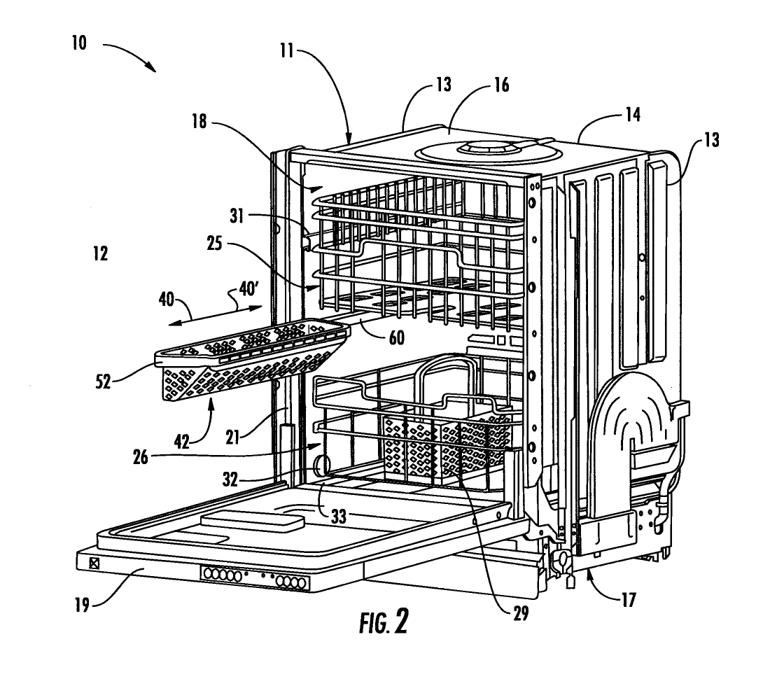

Referring now to the drawings in which like numerals indicate like parts throughout the several views, FIGS. 1 and 2 generally illustrate a dishwasher 10 including a wash cabinet or tub 11 in which the basket assembly 12, according to at least one embodiment of the present disclosure, is mounted. The tub 11 generally includes side panels 13, a rear panel 14, and upper and lower portions or panels 16 and 17, which define an open ended wash chamber 18 in which dishes, cooking utensils, pots, pans, etc. are received for washing. A door 19 is pivotally attached to the tub 11, as shown proximate the lower panel 17, and is pivotable from an open position as shown in FIGS. 1 and 2, to a closed position so as to enclose and seal the open front end 21 of the wash tub 11 with a water-tight seal, such as during a washing/cleaning operation or cycle.

As additionally illustrated in FIGS. 1 and 2, the dishwasher 10 further generally includes upper and lower racks 25 and 26 for containing and supporting the dishes and/or cookware within the dishwasher. The racks can be adjustably mounted within the wash chamber 18 of the tub 11 so as to be movable between varying positions to accommodate different height or size dishware or cookware for cleaning. For example, the upper rack 25 can be adjusted vertically with respect to the lower rack 26 as needed to accommodate larger or taller glasses, stemware, or for receipt of large bowls or the like. Additionally, each of the racks 25 and 26 generally comprise a frame 27, typically made from a coated wire, plastic or composite material having sufficient strength and rigidity to support the dishes or cookware received therein. The racks further generally include a series of posts, trays, or other frame elements 28 and/or can include a utensil basket 29, which can be configured or adapted to receive and hold various different types of utensils or cookware. Each of the racks further generally will be mounted on slides 31 or rollers and tracks 32/33 to enable the racks 25 and 26 to be slid or otherwise moved in a horizontal direction into and out of the wash chamber 18 of the tub 11.

As shown in FIG. 2, the basket assembly 12 generally includes an elongate basket body 42 that is slidably supported within the wash chamber 18 on a slide mechanism 60 so as to be movable in a horizontal direction, as indicated by arrows 40/40′ in FIG. 2, into and out of the wash chamber 18 of the dishwasher 10. The movement of the basket body 42 between the interior of the wash chamber 18 and the exterior of the wash chamber can be independent of movement of the upper rack 25 and the lower rack 26. In addition, and as described in more detail below, the basket body 42 can be removably attached to the slide mechanism 60 with one or more attachment fixtures. Thus, the basket body 42 may be alternately detachable from the slide mechanism 60 for removal from the wash chamber 18, as well as attachable with the slide mechanism 60 for installation within the wash chamber 18.

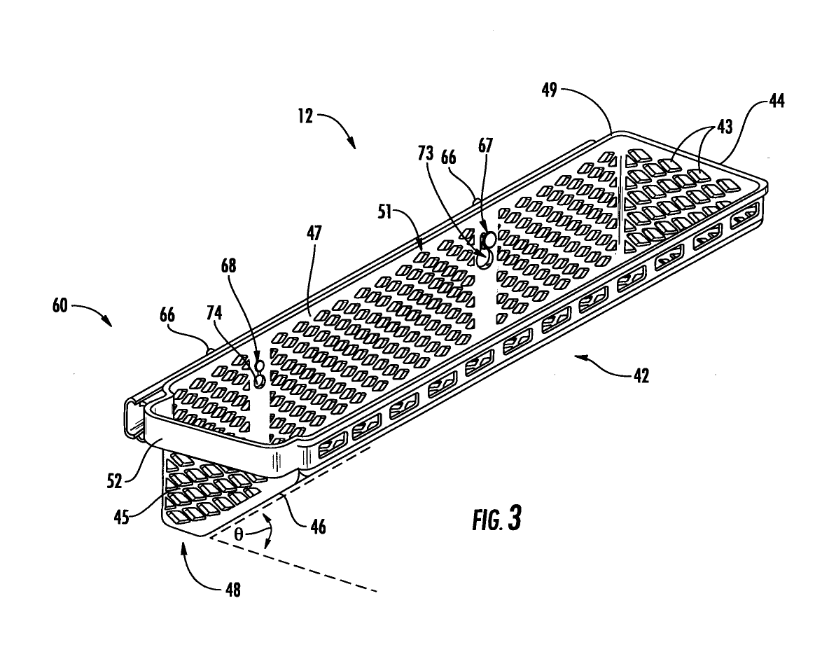

One representative embodiment of the basket assembly 12 is shown in greater detail in FIG. 3, and includes the basket body 42 and the slide mechanism 60. In general, the basket body 42 can be formed from a plastic, synthetic or a coated metal material, and can further include a series of openings 43 formed in one or more of the base 48, the rear end wall 44, the forward end wall 45, the inner sidewall 46 and the outer sidewall 47 to facilitate passage of water therethrough during a washing and cleaning operation. The basket body 42 can include an elongate shape for loading and unloading of elongate and/or irregularly shaped articles, such as knives, cooking spoons, spatulas, tongs, and/or various other types of utensils or cookware therein. Although the basket body 42 of the basket assembly 12 shown in FIG. 3 has a substantially triangular or trapezoidal shape or configuration, it will be understood by those skilled in the art that various other configurations, including rectangular, substantially cylindrical and/or other shapes or configurations also can be used.

In the illustrated embodiment, outer sidewall 47 generally is shown as being substantially flat and extending vertically from the bottom or base 48 of the basket body 42, while inner side wall 46 is illustrated as extending upwardly and away from the base 48 at an angle θ, typically between 30°-80° relative to horizontal or the plane of the base 48, although greater or lesser angles can also be used. The sidewalls 46 and 47 terminate at an open upper end 49, thus defining a chamber or receptacle 51 in which the elongate and/or irregularly shaped cooking utensils or other articles can be received. As illustrated in FIG. 3, the receptacle 51 can have an open top for easy placement and removal of the elongate utensils. Optionally, the basket body 42 can include a hinged cover (not shown) which can be received over the open upper end 49 to close the open top in an effort to further secure the articles within the receptacle 51.

With the basket body 42 installed within the wash chamber 18, the angled or sloped configuration of inner sidewall 46, which is angled inwardly toward a center of the wash chamber 18 and away from the side panel 13 of the wash tub 11 (FIGS. 1-2), is generally configured so as to enable the basket assembly 12 to slide into and out of the wash chamber 18 of the dishwasher without interfering with or engaging the cookware, such as dishes, pots, pans, etc., loaded within the lower rack 26. Additionally, a handle 52 can be formed or mounted proximate the front end wall 45 of the basket body 42. The handle 52 can provide a portion of the basket for gripping by the user to enable the basket to be pulled and/or pushed in the direction of arrows 40 and 40′ (FIG. 2) to move the basket assembly into and out of the wash chamber of the dishwasher.

In an alternative embodiment (not shown), both the outer sidewall and the inner sidewall of the basket body can extend upwardly from the base of the basket body towards the open upper end of the receptacle, while the base itself is angled upwardly and away from a bottom portion of the outer sidewall to a bottom portion of the inner sidewall, and at an acute angle relative to the outer sidewall. In this case, the acute angle can be between 30°-60° relative to vertical or the plane of the outer sidewall, and the overall height of the inner sidewall (as measured in the vertical direction) can be substantially less that the height of the outer sidewall.

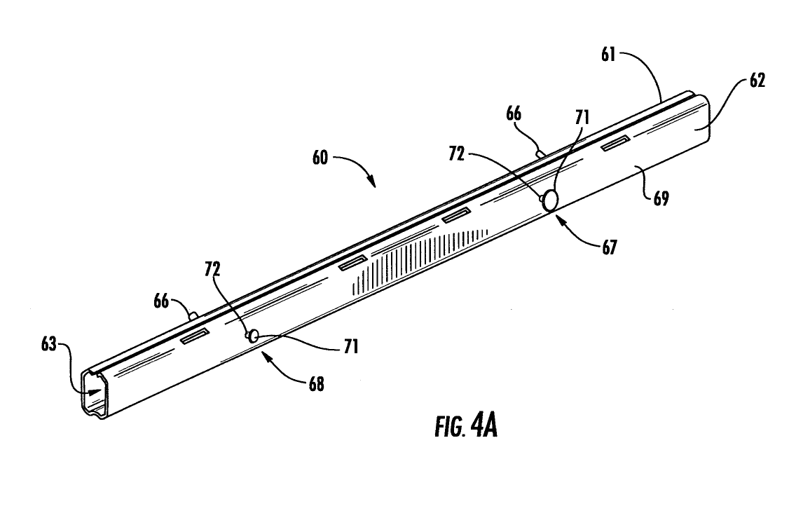

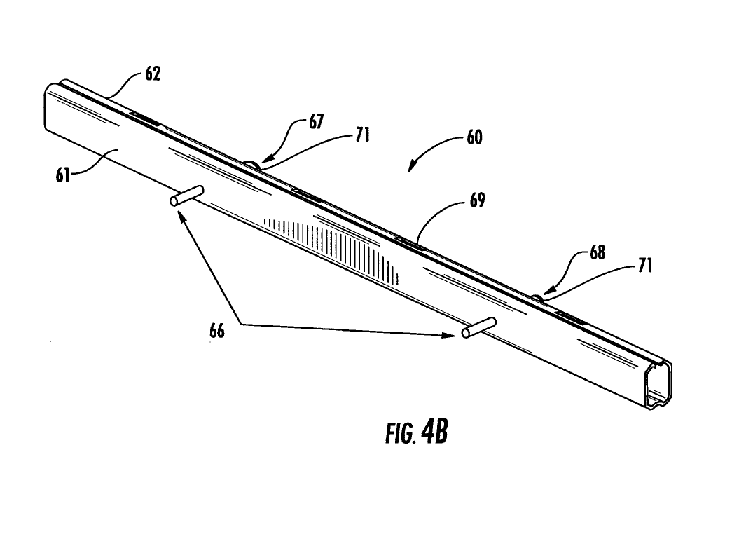

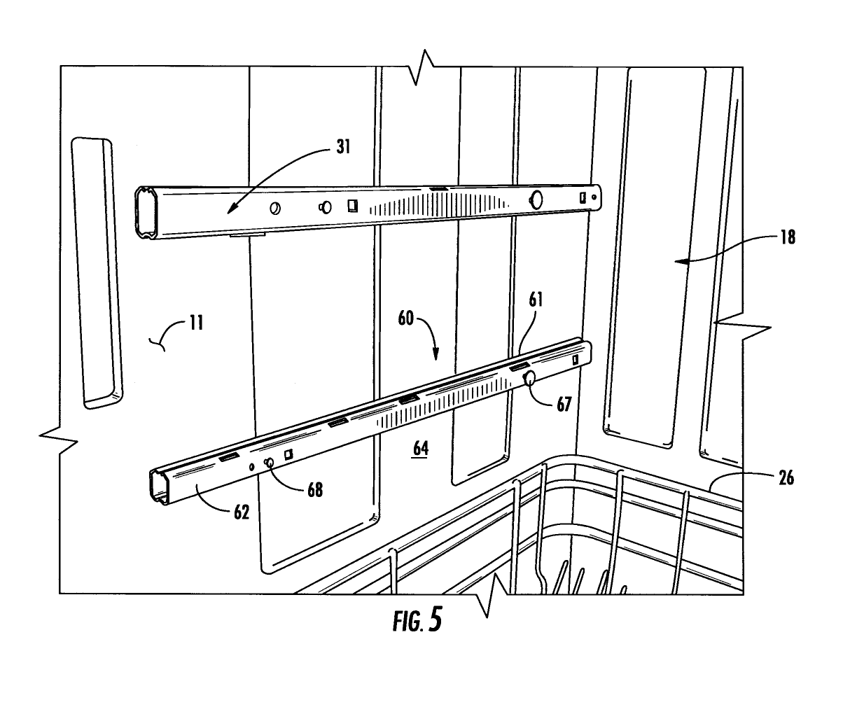

The basket assembly 12 illustrated in FIGS. 1-3 above generally includes a retractable slide mechanism 60 which both supports the basket body 42 and facilitates the smooth sliding movement of the basket body 42 into and out of the wash chamber 18. The slide mechanism 60 can be mounted to either side panel of the tub 11, and can comprise a variety of slides, guide rails or similar mechanisms. The slide mechanism 60 can also comprise materials that are resistant to corrosion, such as stainless steel, plastic, or similar corrosion resistant materials. In a representative embodiment of the slide mechanism 60 illustrated in FIGS. 4A, 4B and 5, for instance, the slide mechanism 60 can include a ball bearing slide or rail assembly which includes a pair of opposed rails 61 and 62 connected together in a telescoping fashion by an internal guide track or bearing assembly 63. The bearing assembly can be sealed against the ingress of soap and hot water, which could negatively affect the mobility of the slide mechanism.

In general, one of the rails, i.e. mounting rail 61, can be mounted within the wash chamber 18 along an inside wall 64 or surface of the tub 11 to secure the slide mechanism 60 thereto, as shown in FIG. 5. Typically, this mounting rail 61 will be positioned at a location spaced below the rail assembly 31 of the upper rack, and will be mounted to the inside wall 64 of the tub by fasteners 66, such as screws, bolts, rivets or other fasteners, as indicated in FIG. 4B. In other aspects of the disclosure, the mounting rail 61 can be mounted to a lower portion or edge of the upper rack so as to be movable independent of, or in conjunction with, the movement of the upper rack into and out of the wash chamber. Alternatively, the mounting rail 61 can be mounted on support members (not shown) that extend upwardly from the lower rack to elevate the basket assembly above the dishes and/or other objects in the lower rack 26, while still allowing the basket body to be withdrawn and inserted within the wash chamber 18 independent of, or in conjunction with, the movement of the lower rack 26 into and out of the wash chamber.

As shown in FIG. 4A, the other of the rails, i.e. rack rail 62, includes an inside facing surface 69 that is adapted to receive and support the basket body 42 thereon (see FIG. 3). To mount the basket body onto the inner rack rail 62 of the slide mechanism 60, various attachment fixtures can be used. For example, a pair of spaced fasteners or flanges 67 and 68 can be mounted along the inside facing surface 69 of the rack rail 62. The fasteners or flanges 67 and 68 can be of the same size, or can be of different sizes as needed or desired, and each generally will include enlarged head portions 71 attached to the ends of posts 72.

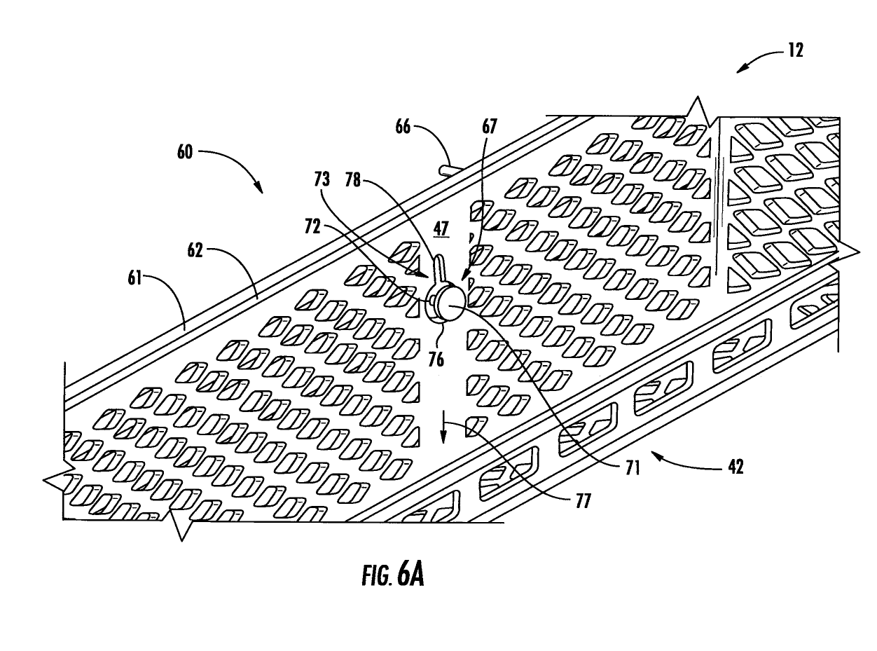

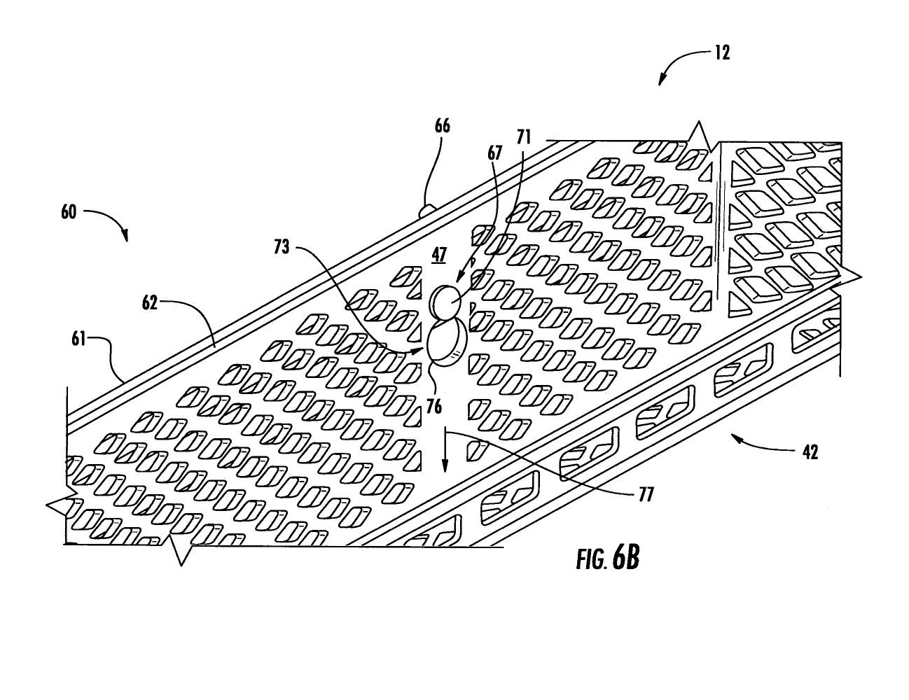

As also shown in FIG. 3, the head portions of the fasteners 67/68 can be received within slotted mounting opening 73/74, respectively, formed into the outer sidewall 47 of the basket body 42. In one representative embodiment of the attachment fixtures illustrated in FIGS. 6A-6B, each of the slotted mounting openings (slotted mounting opening 73 is shown) generally includes an enlarged, substantially circular shaped lower portion 76, which generally is of a size sufficiently larger than the head portion 71 of its flange 67 to facilitate receipt of the head portion 71 therein, as indicated in FIG. 6A. Thereafter, as illustrated in FIG. 6B, the basket body 42 can be moved downwardly, in the direction of arrow 77, thereby engaging a notch or recess 78 at the upper end of the mounting opening 73 with the post 72 of the flange 67, so that the flange 67 is received and secured within the mounting opening 73. As a result, the basket body 42 can be quickly and easily mounted to or removed from the slide mechanism 60 without additional tooling, such screwdrivers, wrenches, pliers and the like.

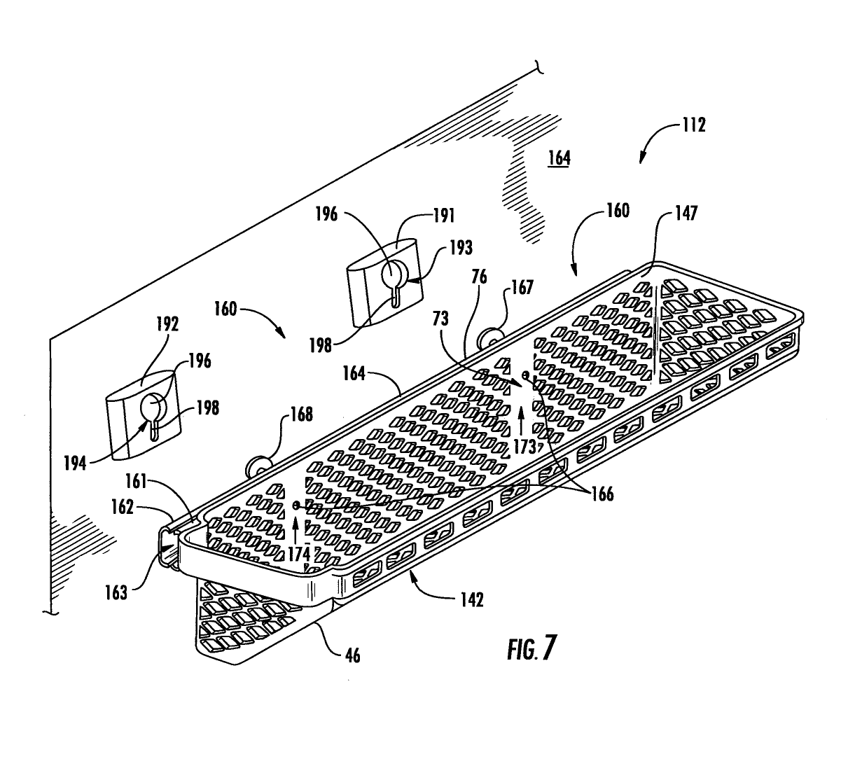

FIG. 7 illustrates another representative embodiment of the basket assembly 112 of the present disclosure. As shown in FIG. 7, the basket body 142 is secured to the slide mechanism 160 with one or more fasteners 166, and the slide mechanism 160 is then alternately detachable and attachable from the side panel 113 of the wash chamber 118. This configuration allows for the simultaneous removal or installation of both the basket body 142 and slide mechanism 160 from or into wash chamber 118, respectively, and without additional tooling, such screwdrivers, wrenches, pliers and the like.

In the configuration of FIG. 7, the slide mechanism 160 can be reversed so that the mounting rail 161 with fasteners 166 is proximate the basket body 142, and the fasteners 166 are received through openings 173, 174 formed into the outer sidewall 147 of the basket body 142. Similar to the embodiments discussed above, the fasteners 166 can comprise screws, bolts, rivets and the like. In addition, the rack rail 162 with a pair of spaced fasteners or flanges 167 and 168 projecting from the outer surface thereof can face the inside wall 164 of the wash chamber. Mounting brackets 191, 192, with complimentary slotted mounting openings 193, 194 similar to those described above, can be attached to the inside wall 164 or surface of the tub to secure the slide mechanism 160 thereto. However, in the embodiment of FIG. 7, the enlarged, substantially circular shaped portion 196 of the openings 193, 194 will now be positioned above the notch or recess 198. The flanges 167/168 of the slide mechanism 160 are movable relative to the openings 193, 194 on the brackets 191/192 that are affixed to the inside wall 164 of the tub. In other aspects, the mounting brackets 191, 192 can be affixed to the upper rack or the lower rack.

As with the previously described embodiment, basket body 142 is slidably supported within the wash chamber 118 by slide mechanism 160 so as to be movable in a horizontal direction into and out of the wash chamber of the dishwasher. The sliding movement of the basket body 142 between the interior of the wash chamber 118 and the exterior of the wash chamber can be independent of movement of the upper and lower racks (not shown). In addition, the basket body 142 (in combination with the slide mechanism 160) may also be entirely removable from the wash chamber as desired to better accommodate pots, pans, dishes and other kitchenware.

In another aspect of the disclosure, one or more additional pairs of mounting brackets 191, 192 can be mounted to the opposite side panel of the wash chamber so that the slide mechanism 160 can be removably attached to either side panel. In this case the bearing mechanism 163 located between mounting rail 161 and rack rail 162 can provide for sliding motion in both directions, and the basket body 142 can be reversible and accessible from either end of the basket assembly 112.

In yet another alternative embodiment of the basket assembly (not shown), a basket body similar to that described above may be pivotably supported within the wash chamber on a pivot mechanism located near the front end 21 of the tub 11 (FIGS. 1-2), so as to be pivotably movable out of wash chamber to provide access to the receptacle formed into the basket body.

The foregoing description generally illustrates and describes various embodiments of the present invention. It will be understood by those skilled in the art that various changes can be made to the above-discussed construction without departing from the spirit and scope of the present invention as disclosed herein, and it is intended that all matter contained in the above description or shown in the accompanying drawings shall be interpreted as illustrative and not limiting. Furthermore, the scope of the present disclosure shall be construed to cover various modifications, combinations, alterations, etc. of the above-described embodiments and shall be considered to be within the scope of the present invention. Furthermore, various features and characteristics of the present invention as discussed herein may be selectively interchanged and applied to other illustrated and non-illustrated embodiments of the invention.

1. A basket assembly for use in a dishwasher having a wash chamber with an upper rack and a lower rack, the upper rack and the lower rack being movable between an interior of the wash chamber and an exterior of the wash chamber, the basket assembly comprising:
a basket body disposed between the upper rack and the lower rack; and
a slide mechanism adapted for attachment with the basket body and the slide mechanism enabling movement of the basket body independent of movement of the upper rack and the lower rack.

2. The basket assembly of claim 1, wherein the basket body is movable between the interior of the wash chamber and the exterior of the wash chamber.

3. The basket assembly of claim 1, wherein a direction of movement of the basket body is substantially parallel to a direction of movement of the upper rack and the lower rack.

4. The basket assembly of claim 1, wherein the basket body is detachable from the slide mechanism without tooling.

5. The basket assembly of claim 1, wherein the slide mechanism includes attachment fixtures for coupling with the basket body.

6. The basket assembly of claim 5, wherein the plurality of attachment fixtures includes flanges having head portions adapted to be received with in recesses formed in a sidewall of the basket body.

7. The basket assembly of claim 1, wherein the slide mechanism is mountable to a side panel of the wash chamber.

8. The basket assembly of claim 7, wherein the slide mechanism further comprises an outer rail mountable to the side panel of the wash chamber, an inner rail having attachment fixtures for attachment to the basket body, and a bearing mechanism between the outer rail and the inner rail for providing sliding linear motion of the inner rail and the outer rail.

9. The basket assembly of claim 1, wherein the basket body is secured to the slide mechanism and the slide mechanism is detachable from a side panel of the wash chamber without tooling.

10. The basket assembly of claim 9, further comprising attachment fixtures extending from a side panel of the wash chamber.

11. The basket assembly of claim 1, further comprising attachment fixtures extending from both side panels of the wash chamber and wherein the basket assembly is reversible for removable attachment to either side panel of the side panels of the wash chamber.

12. The basket assembly of claim 1, further comprising a handle in a portion of the basket body.

13. The basket assembly of claim 1, wherein the basket body comprises a receptacle having an elongate base, a first elongate sidewall extending upwardly from the base, and a second elongate sidewall extending upwardly and outwardly from the base at an acute angle relative to the base.

14. The basket assembly of claim 13, wherein the acute angle is between 30 degrees and 80 degrees.

15. The basket assembly of claim 13, wherein the receptacle has an open top.

16. A dishwasher for cleaning articles, the dishwasher comprising:
a base panel, a back panel, a top panel, and first and second side panels defining a wash chamber having a front opening;
a door configured to close the front opening;
an upper rack and a lower rack being movable to extend through the front opening;
a basket body disposed between the upper rack and the lower rack; and
a slide mechanism supporting the basket body and enabling movement of the basket body to extend through the front opening independent of movement of the upper rack and the lower rack.

17. The dishwasher of claim 16, wherein the basket body is detachable from the slide mechanism without tooling for removal from the wash chamber.

18. The dishwasher of claim 16, wherein the slide mechanism is mounted to a side panel of the wash chamber.

19. The dishwasher of claim 16, wherein the basket body comprises a receptacle having an elongate base, a first elongate sidewall extending upwardly from the base, and a second elongate sidewall extending upwardly and outwardly from the base at an acute angle relative to a the base.

20. The dishwasher of claim 19, wherein the acute angle is between 30 degrees and 80 degrees.

21. A method of cleaning utensils in a dishwasher having a wash chamber with an upper rack and a lower rack being movable between an interior of the wash chamber to an exterior of the wash chamber, the method comprising:
attaching a basket body to a slide mechanism mounted to the upper rack, the lower rack, or a side panel of the wash chamber;
sliding the basket body on the slide mechanism to the exterior of the wash chamber, the sliding movement of the basket body being independent of movement of the upper rack and the lower rack;
placing at least one utensil within the basket body; and
sliding the basket body on the slide mechanism into the interior of the wash chamber.

22. The method of claim 21, wherein the basket body is attachable to the slide mechanism without tooling.
